(19) United States
(12) Patent Application Publication
(10) Pub. No.: US 2014/0065516 A1
(43) Pub. Date: Mar. 6, 2014

(54) Mixed-Metal Platinum Catalysts With Improved Carbon Monoxide Tolerance

(71) Applicants: Emmanouil Mavrikakis, Madison, WI (US); Anand U. Nilekar, Houston, TX (US); Radoslav R. Adzic, East Setauket, NY (US); Kotaro Sasaki, Ronkonkoma, NY (US)

(72) Inventors: Emmanouil Mavrikakis, Madison, WI (US); Anand U. Nilekar, Houston, TX (US); Radoslav R. Adzic, East Setauket, NY (US); Kotaro Sasaki, Ronkonkoma, NY (US)

(73) Assignee: Wisconsin Alumni Research Foundation, Madison, WI (US)

(21) Appl. No.: 13/604,891

(22) Filed: Sep. 6, 2012

(51) Int. Cl. H01M 4/92

(52) U.S. Cl. CPC H01M 4/921
USPC 429/505; 429/524

(57) ABSTRACT

Disclosed are catalysts, especially catalytic anodes, useful for catalyzing reactions in fuel cells and in other environments. The catalysts have a substrate base made of iridium and/or ruthenium. There is a very thin coating on the substrate which is a mix of platinum and at least one metal selected from gold, palladium, iridium, rhodium, ruthenium, rhenium, and osmium. The anodes are resistant to carbon monoxide adulteration.

### CROSS-REFERENCE TO RELATED APPLICATIONS

Not applicable.

### STATEMENT REGARDING FEDERALLY SPONSORED RESEARCH/DEVELOPMENT

This invention was made with government support under DE-FG-02-05ER 15731 and DE-AC02-98CH10886 awarded by the Department of Energy. The government has certain rights in the invention.

### BACKGROUND OF THE INVENTION

The present invention relates to catalysts, preferably electrocatalysts such as anodes. More particularly it relates to mixed-metal platinum catalysts that are resistant to carbon monoxide adulteration.

Developing effective catalysts is important for a wide range of applications; for example, in electrodes that are used in hydrogen and methanol fuel cells to render them more efficient.

Platinum anodes are particularly useful in low-temperature hydrogen fuel cells. However, even trace amounts of carbon monoxide may adulterate such (and other) platinum catalysts, resulting in inefficiencies and the need for premature replacement. Moreover, platinum is a very expensive metal.

Various experimental and theoretical studies have focused on trying to optimize the use of platinum catalysts. See S. Brankovic et al., Pt Submonolayers on RU Nanoparticles: A Novel Low Pt Loading, High CO Tolerance Fuel Cell Electrocatalyst, 4 Solid State Lett. A217-A220 (2001); H. Gasteiger et al., H₂ and CO electrooxidation on well-characterized Pt, Ru, and Pt—Ru . . . , 99 J. Phys. Chem. 16757-67 (1995); S. Mukerjee et al., Investigation of Enhanced CO Tolerance in Proton Exchange Membrane Fuel Cells by Carbon Supported PtMo Alloy Electrocatalysts, 2 Electrochem. Solid State Lett. 12-15 (1999); P. Liu et al., Modeling the electro-oxidation of CO and H₂/CO on Pt, Ru, PtRu and Pt₃Sn, 48 Electrochim. Acta 3731-3742 (2003); J. Davies et al., The Ligand Effect: CO Desorption from Pt/Ru Catalysts, 5 Fuel Cells 429-435 (2005).

One approach is to create alloys of platinum instead of using just pure platinum. For example, PtRu, PtMo, PtZn, PtSn and other alloys were proposed as catalytic materials. M. Watanabe, Handbook of Fuel Cells—Fundamentals, Technology and Applications; Wiley: Hoboken, N.J. 408-415 (2003); CO-tolerant anode catalyst for PEM fuel cells and a process for its preparation, per U.S. Pat. No. 6,007,934; CO tolerant platinum-zinc fuel cell electrode, per U.S. Pat. No. 5,916,702; CO-tolerant fuel cell electrode, per U.S. Pat. No. 5,922,488; carbon monoxide tolerant electrocatalyst with low platinum loading and a process for its preparation, per U.S. Pat. No. 6,670,301; and platinum, tungsten, and nickel or zirconium containing electrocatalysts, per U.S. Pat. No. 7,435,504.

Other researchers focused on the oxygen reduction reaction (ORR) occurring at the cathode side of fuel cells. By depositing a single platinum monolayer on other metal substrates, the reactivity of platinum atoms could be manipulated for this purpose. J. Zhang et al., Controlling the Catalytic Activity of Platinum-Monolayer Electrocatalysts for Oxygen Reduction with Different Substrates, 44 Angew. Chem., Int. Ed. 2132-2135 (2005).

Further, it was reported that the replacement of a fraction of platinum overlayer atoms with atoms of a more oxophillic metal yielded improvements for the ORR when the base substrate was palladium. See J. Zhang et al., Mixed-Metal Pt Monolayer Electrocatalysts for Enhanced Oxygen Reduction Kinetics, 127 J. Am. Chem. Soc. 12480-81 (2005). However, forming discrete monolayers on base metals to facilitate this approach can prove a daunting challenge, particularly when other metals besides palladium are tried.

In any event, further improvements are desired in developing catalysts that are resistant to carbon monoxide adulteration, achieve desired performance characteristics, and are not unduly expensive.

### SUMMARY OF THE INVENTION

In one aspect the invention provides a catalyst (such as in a catalytic anode) that has a substrate formed of a material selected from the group consisting of iridium and ruthenium. A mixed-metal coating/overlayer is positioned on the substrate, the coating being formed from platinum and at least one material selected from the group consisting of gold, palladium, iridium, ruthenium, rhodium, rhenium, and osmium. Most preferably the coating/overlayer is essentially atomic-monolayer thick (mostly less than two atoms thick).

We prefer that the coating contain at least one material selected from the group consisting of iridium and osmium, and have between 5% and 95% platinum by weight. For example, in some preferred embodiments the coating has between 20% and 30% platinum by weight, and in others between 60% and 80% platinum by weight. The selected materials can be in varied forms (e.g. nanoparticle or crystalline). Using iridium as the substrate is particularly preferred.

In one form the mixed-metal coating was deposited on the substrate by galvanic displacement of a copper monolayer on the substrate.

In another aspect the invention provides a method for generating electricity in a hydrogen fuel cell. One obtains a fuel cell comprising such an anode and a cathode. One then exposes hydrogen gas to the anode and thereby generates electricity (regardless of whether carbon monoxide is present).

In the past low temperature fuel cells using platinum catalysts have been particularly sensitive to the presence of carbon monoxide. By substituting an anode of the present invention for a conventional platinum anode, catalytic activity can be maintained but with the anode being more resistant to carbon monoxide adulteration. Thus, using the anodes of the present invention hydrogen “fuel” can be used to generate electricity, and that electricity is then available for a wide variety of purposes (e.g. powering an automobile or other portable electronic devices).

The above and still other advantages of the present invention will be apparent from the description that follows. It should be appreciated that the following description is merely of preferred embodiments of our invention. The claims should therefore be looked to in order to understand the full claimed scope of the invention.

### BRIEF DESCRIPTION OF THE DRAWINGS

FIG. 1 shows theoretical carbon monoxide-carbon monoxide interaction energies based on density functional theory calculations; and

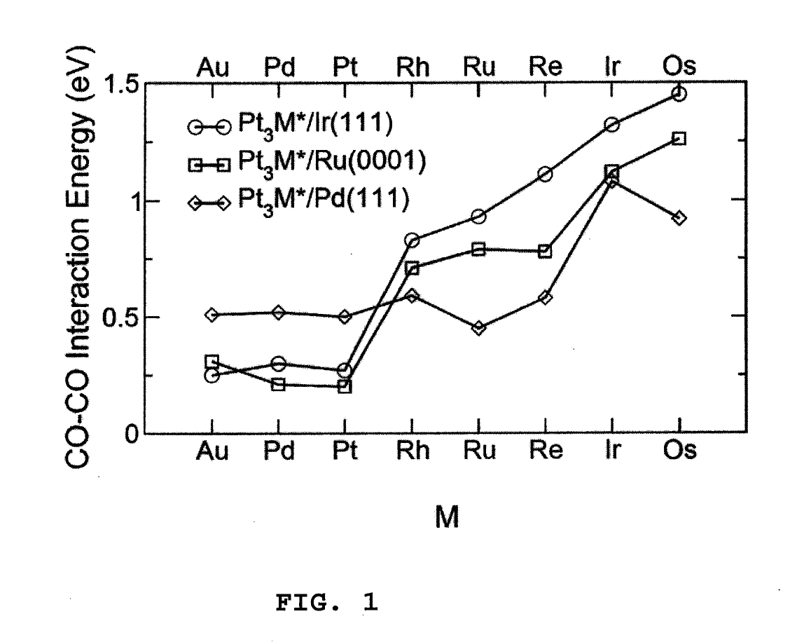

FIG. 2 shows the carbon monoxide stripping potential of various platinum-metal monolayers on an iridium substrate, as a function of carbon monoxide-carbon monoxide repulsion energy.

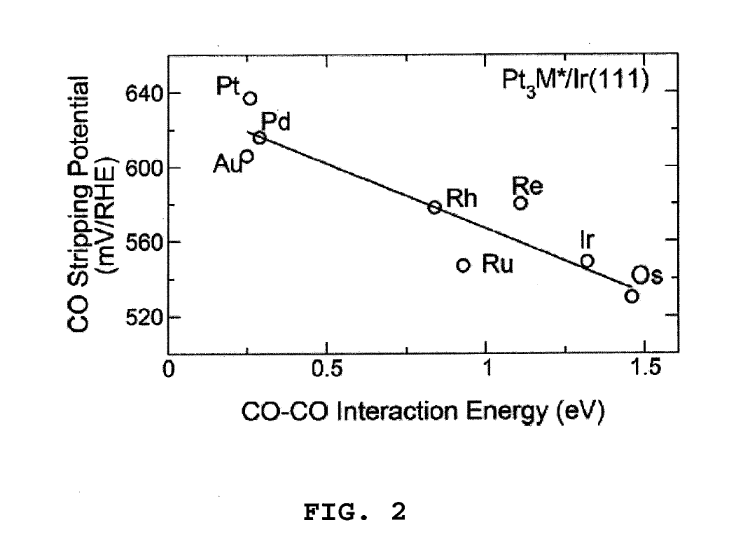

### DESCRIPTION OF THE PREFERRED EMBODIMENTS

We describe below a new class of catalysts. By using iridium or ruthenium base substrates, and careful selection of other metals to be mixed within a platinum overlayer, we provide catalysts that are very resistant to carbon monoxide adulteration. These catalysts are particularly well suited for use in fuel cells.

We describe below initial experimental efforts on systems with crystalline Ir(111) as the support for a Pt₃M overlayer (M=Au, Pt, Pd, Ir, Rh, Re, or Os). We performed oxidative carbon monoxide desorption experiments on these model surfaces.

Carbon monoxide adsorption on the resultant constructs were performed by holding them in a HClO₄ solution at a constant potential of 0.23 V (at which no carbon monoxide oxidation takes place on the surface) while CO is introduced into the cell. CO was then removed from the solution through purging by argon in order to study its anodic stripping from the surface. We evaluated the oxidative CO desorption from Pt₃Pd and Pt₃Ir, both supported on Ir(111), by sweeping the potential from 30 mV.

Carbon monoxide adlayers on the surfaces exhibited completely suppressed peaks in the hydrogen adsorption/desorption region. The onset of CO oxidation occurs at a less positive potential on the Pt₃Ir*/Ir(111) surface (0.55 V) than on the Pt₃Pd*/Ir(111) surface (0.62 V), albeit both lower than that on a pure Pt(111) surface (˜0.70 V). This indicates a significant effect of the addition of a coating of the present invention on the bonding of CO to the catalytic surface, and also the enhanced CO—CO repulsion. The CO stripping potential drops from ˜0.7 V on pure Pt(111) to 0.64 V for Pt*/Ir(111), because of weaker Pt—CO binding due to the compressive strain imparted by the Ir(111) substrate on the Pt overlayer in addition to the strong bond developed between Pt (overlayer) and Ir (substrate) atoms.

An additional ˜100 mV decrease in the CO-stripping potential is realized by going from Pt*/Ir(111) to Pt₃Ir*/Ir(111) or Pt₃Os*/Ir(111). This additional improvement originates from the increased repulsive interaction between CO molecules on the bimetallic Pt₃M overlayer, due to the platinum-iridium ligand effect within the overlayer.

We next describe our methods for forming the Pt-M/Ir or Pt-M/Ru constructs. With respect to the iridium substrate variants, a 6 mm in diameter Ir(111) single crystal can be obtained from Metal Crystal and Oxides, Cambridge, England. With an additional orientation, the surface can be oriented to better than 0.1°. The crystal surface can then be polished with diamond and pastes and alumina down to 0.05 μm.

The crystal can then be annealed by inductive heating in an Ar atmosphere. Protected by a drop of ultrapure water, the crystal can then be transferred to a multi-compartment electrochemical cell in an Ar atmosphere.

The Pt-M monolayer on the Ir(111) surface can then be prepared by the galvanic displacement of an underpotentially deposited (UPD) Cu monolayer. See S. Brankovic et al., Brankovic, S. R., Wang, J. X. & Adzic, R. R. Metal monolayer deposition by replacement of metal adlayers on electrode surfaces. Surf. Sci. 477, L173-L179 (2001).

After depositing a Cu adlayer on the Ir surface, the electrode is rinsed to remove Cu²⁺ from the solution film, and immersed in a stoichometrically mixed solution of Pt and M chlorides. See also J. Zhang et al., Platinum Monolayer Electrocatalysts for O₂ Reduction: Pt Monolayer on Pd(111) and on Carbon-Supported Pd Nanoparticles, 108 Journal Of Physical Chemistry B 10955-10964 (2004)(platinum chloride)

An analogous technique can be used with respect to a ruthenium substrate. In this regard, S. Brankovic et al., Pt Submonolayers On Ru Nanparticles, 4 Electrochemical and Solid State Letters A217-A220 (2001) describes preparation of a Ru substrate.

In sum, we initially identified as possible anode candidates a fairly large number of mixed-metal Pt monolayer compositions supported on other metals. We then identified a small set of highly promising CO-tolerant Pt-M mixed monolayers supported on specifically selected substrate metals (iridium and ruthenium). We then developed techniques to synthesize thin mixed-metal platinum monolayer coatings on iridium and ruthenium.

Our catalysts showed high reactivity and low overpotential for CO-stripping compared to pure Pt(111). These catalysts should therefore present attractive alternatives to existing catalysts as a result of their potential for decreased cost, high Pt mass-specific activity, enhanced CO tolerance, and resultant reduction in overpotential for electro-oxidation of H₂ in the presence of CO.

The molecular-level understanding provided by our calculations (see generally our article in 133 J. Am. Chem. Soc. 185474-18756 (Oct. 25, 2011)(incorporated by reference as if fully set forth herein) suggests that enhanced CO tolerance originates from an increased repulsive interaction between adsorbed CO molecules, mediated by the novel electronic structure of these bimetallic monolayer surfaces which are supported by specific non-platinum metal.

While we initially propose use of these catalysts as anodes in hydrogen fuel cells, it is expected that they will have a variety of other useful applications. For example, they likely will make good electrodes in a direct methanol or dimethyl ether or other fuel cell environments, where the fuel molecule contains carbon, oxygen, and hydrogen atoms in general.

Moreover, these catalysts will likely form desirable catalysts in a variety of environments that don't even involve generation or use of electricity. In essence, wherever a platinum catalyst is currently used, and the operation is limited by carbon monoxide adulteration, we suggest the consideration of our catalysts for that application as well. An example of such a further application may include hydrogen, fuels, and chemicals production from biomass-derived molecules, which tend to lead to catalyst adulteration by carbon monoxide. We are replacing most of the platinum otherwise used with lower cost materials, and rendering the catalyst more resistant to carbon monoxide adulteration.

### INDUSTRIAL APPLICABILITY

The present invention provides improved catalysts, particularly for use as anodes in hydrogen fuel cells, and methods for operating such fuel cells using such anodes.

We claim:

1. A catalyst, comprising:
a substrate comprising a material selected from the group consisting of iridium and ruthenium; and
a mixed-metal coating on the substrate comprising platinum and at least one material selected from the group consisting of gold, palladium, iridium, ruthenium, rhodium, rhenium, and osmium.

2. The catalyst of claim 1, wherein the coating is essentially atomic-monolayer thick.

3. The catalyst of claim 1, wherein the catalyst is an anode.

4. The catalyst of claim 3, wherein the coating comprises at least one material selected from the group consisting of iridium and osmium.

5. The catalyst of claim 3, wherein the substrate comprises iridium.

6. The catalyst of claim 3, wherein the coating comprises at least 5% platinum by weight.

7. The catalyst of claim 6, wherein the coating comprises between 20% and 30% platinum by weight.

8. The catalyst of claim 3, wherein the coating comprises less than 95% platinum by weight.

9. The catalyst of claim 8, wherein the coating comprises between 60% and 80% platinum by weight.

10. The catalyst of claim 3, wherein at least one of the substrate and coating comprises at least one of such materials in crystalline or nanoparticle form.

11. The catalyst of claim 1, wherein coating was deposited on the substrate by galvanic displacement of a copper layer on the substrate.

12. A method for generating electricity in a fuel cell, comprising the steps of:
obtaining a fuel cell comprising an anode and a cathode;
exposing the anode to hydrogen gas and thereby generating electricity;
wherein the anode comprises an anode of claim 3.

13. The method of claim 12, wherein the method is conducted in the presence of carbon monoxide.
